(19) United States
(12) Patent Application Publication
(10) Pub. No.: US 2020/0327105 A1
(43) Pub. Date: Oct. 15, 2020

(54) METHOD AND SYSTEM FOR SCORING AUTOMOTIVE DATA

(71) Applicant: OTONOMO TECHNOLOGIES LTD., Even Yehuda (IL)

(72) Inventor: Gil-ad MEIR, Qiryat Ono (IL)

(73) Assignee: OTONOMO TECHNOLOGIES LTD., Even Yehuda (IL)

(21) Appl. No.: 16/383,715

(22) Filed: Apr. 15, 2019

(51) Int. Cl. G06F 16/215; G06F 16/2457; G06F 16/23; G07C 5/00; G07C 5/08

(52) U.S. Cl. CPC G06F 16/215; G06F 16/24578; G07C 5/0841; G07C 5/008; G06F 16/2365

(57) ABSTRACT

A method and a system for scoring automotive data related to connected vehicles and originated from a plurality of data sources are provided herein. The method may include the following steps: obtaining processed automotive data records originated from a plurality of data sources related to a plurality of connected vehicles; collecting statistic information from said processed automotive data records, based on selected scoring metrics, wherein the statistic information comprise real-time statistical representation of the processed automotive data records in view of the selected scoring metrics; and applying a grading scheme to the statistic information, to yield a score for at least one of: the data sources, the data records, wherein the grading scheme is tailored per one of a plurality of use cases for automotive data consumption. The system implements the method over a server-client architecture.

### FIELD OF THE INVENTION

The present invention relates generally to the field of data processing, and more particularly to processing of automotive data over a computer network.

### BACKGROUND OF THE INVENTION

Prior to the background of the invention being set forth, it may be helpful to provide herein definitions of certain terms that will be used hereinafter.

The term “connected vehicle” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein to as “automotive data”.

The term “data marketplace” or “data market” as used herein is defined as an online computerized platform that enables a plurality of data consumers to access and consume data. Data marketplaces typically offer various types of data for different markets and from different sources. Common types of data consumers of the automotive data marketplace may include the following domains: financial and insurance institutions, entertainment and navigation applications, safety and emergency, demography and research and many more.

In an automotive data marketplace, it is important to evaluate each data record by a unique set of properties, so that data consumers may be able to decide if and how to consume a specific data record, a cluster of data records or even to evaluate an entire data source.

The assessment of the automotive data is particularly important as data can be used for any mission critical applications such as accidents identification, dangerous roads marking, traffic loads balancing and the like.

### SUMMARY OF THE INVENTION

In order for the challenges of scoring automotive data records and automotive date sources to be addressed, it has been suggested by the inventor of the present invention to carry out the scoring in view of the data attributes associated with the automotive data records and automotive data sources, wherein each data attribute is measured by a set of features. The score can thus be given to the features and applied to the data record or the data source.

The automotive data space has unique characteristics, and the data consumption patterns tend to vary over different use cases. Therefore, in accordance with some embodiments of the present invention, a grading scheme that allocates varying scores to same features in different data consumption use cases is provided.

According to some embodiments of the present invention, a method and a system for scoring automotive data related to connected vehicles and originated from a plurality of data sources are provided herein. The method may include the following steps: obtaining processed automotive data records originated from a plurality of data sources related to a plurality of connected vehicles; collecting statistic information from said processed automotive data records, based on selected scoring metrics, wherein the statistic information comprise real-time statistical representation of the processed automotive data records in view of the selected scoring metrics; and applying a grading scheme to the statistic information, to yield a score for at least one of: the data sources, the data records, wherein the grading scheme is tailored per one of a plurality of use cases for automotive data consumption. The system implements the method over a server-client architecture.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a non-limiting exemplary architecture of a marketplace server capable of scoring the automotive data processed by it, in accordance with some embodiments of the present invention;

FIG. 2 is a block diagram illustrating in further details a possible implementation of an automotive data scoring module in accordance with some embodiments of the present invention; and

FIG. 3 is a high-level flowchart illustrating a non-limiting exemplary method in accordance with embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

According to some embodiments of the present invention, a system for scoring automotive data related to connected vehicles and originated from a plurality of data sources is provided herein. The server in accordance with some embodiments of the present invention may include a data scoring module implemented over a computer processor and configured to obtain processed automotive data records originated from a plurality of data sources related to a plurality of connected vehicles. The system may further include a plurality of clients connected to the server over a network and associated with a plurality of data consumers, wherein the data scoring module may include: a statistic information collector configured to collect statistic information from said processed automotive data records, based on selected scoring metrics, wherein the statistic information comprise real-time statistical representation of the processed automotive data records in view of the selected scoring metrics; and a grader configured to apply a grading scheme to the statistic information, to yield a score for at least one of: the data sources, the data records, wherein the grading scheme is tailored per one of a plurality of use cases for automotive data consumption.

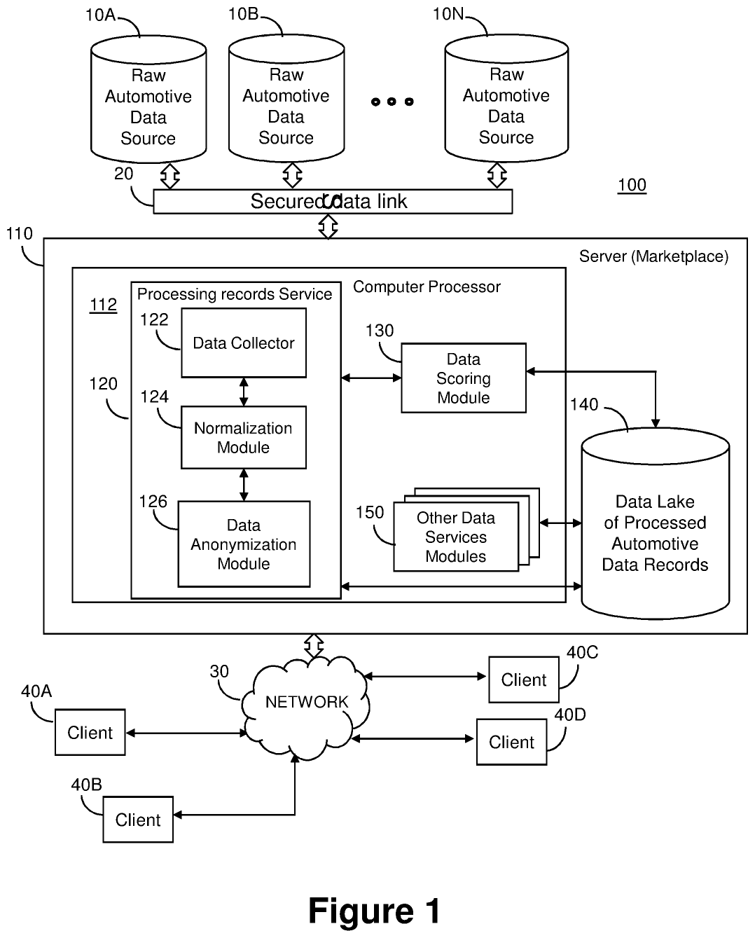

FIG. 1 is a block diagram illustrating in further details a non-limiting exemplary architecture 100 of a marketplace server 110 capable of scoring the automotive data processed by it. Server 110 may be connected, possibly by a secured data link 20 to a plurality of raw automotive data sources 10A, 10B . . . 10N which hold data, possibly in raw format, of various entities, such as, but not limited to, connected vehicles. Server 110 may also be connected, via network 30 to a plurality of clients 40A-40D associated with automotive data consumers.

Server 110 may include a computer processor 112 on which a processing records service 120 may be implemented. Processing records service 120 may be configured to obtain data entries from raw automotive data sources 10A, 10B . . . 10N and process them by possibly collecting (e.g., by data collector 122), normalizing (e.g., by normalization module 124), and anonymizing (e.g., by anonymization module 126) the automotive data records.

The processed data records are stored on a data repository such as a data lake 140 suitable for storing a very large amount of processed automotive data records.

Server 110 may further include a data scoring module 130 configured to obtain the processed automotive records and associate the data records with respective score that may be related to one or more aspects of the data and/or the source of that data, so that the data consumers requesting the automotive data via clients 40A-40D and over network 30 are made aware of the respective score so they may factor it in accordingly when assessing the validity and other properties of the automotive data.

Server 110 may further include a plurality of other data services modules 150 implemented over computer processor 120. Other data services modules 150 may further manipulate, process, and analyze the automotive data on server 110 taking into account the respective score associated with the automotive data in accordance with data scoring module 130 which further updates the data score records on data lake 140 periodically whenever the score of either a data record or a source of that data records has been changed.

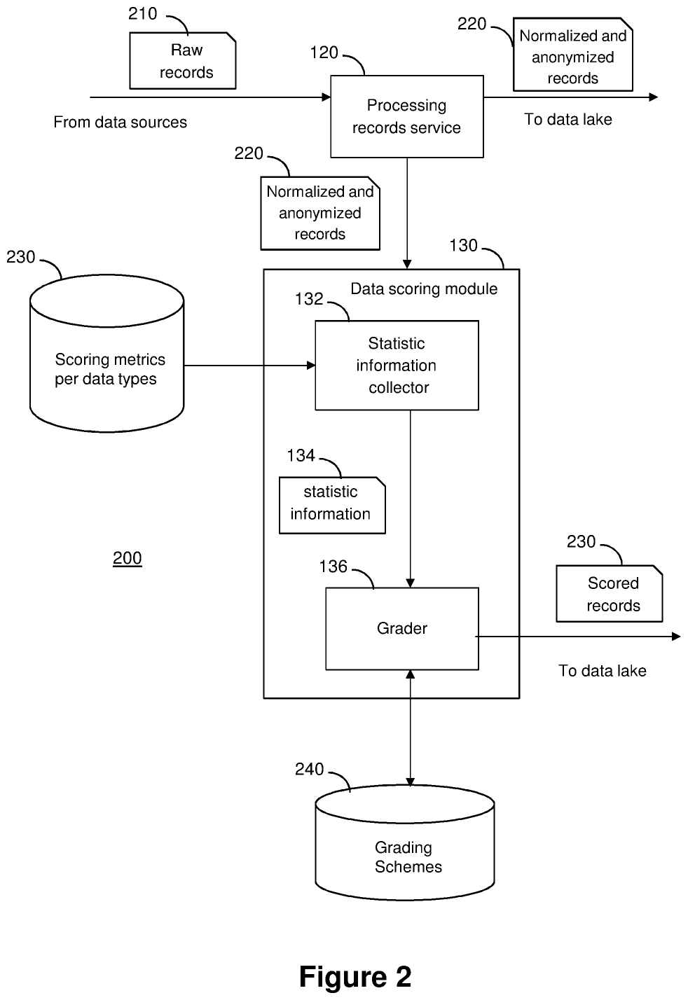

FIG. 2 is a block diagram illustrating in further detail a possible implementation environment 200 of an automotive data scoring module 130 in accordance with some embodiments of the present invention. Processing records service 120, as explained above, may be configured to receive raw records 210 from data sources (not shown) and produce normalized and anonymized records 220 for storing on a data lake (not shown). Data scoring module 130 may be configured to receive normalized and anonymized records 220 and may be further configured to obtain, for all data types, a list of metrics to check, from a database storing scoring metrics per data types 230. Scoring metrics per data types 230 may be generated over time by studying automotive data consuming patterns, possibly by employing machine learning techniques.

In accordance with some embodiments of the present invention, the ability to ingest bulk of data records and receive as an output a score about the quality of the data is based on statistical data as detailed below. The data scoring ability is based on the way server 110 of FIG. 1 collects statistics, metrics, and other information about specific data parameters of specific vehicles under specific data provider at specific time range. Scoring metrics per data types 230 and normalized and anonymized records 220 are fed into a statistic information collector 132 which in turn provides statistic information 134. Statistic information 134 indicates statistical relationship between any of the following: specific data record, data record clusters, data record type, and data sources on one hand, and the yield specific data consumers are gaining from them, on the other hand. The statistic information is very dynamic, and may change from one use case to another, and varies over different data consumers.

According to some embodiments of the present invention, statistic information 134 may be applied to a grader 136 which is fed by various grading schemes 240. Grading schemes 240 may be either defined per class or they may be user defined. Grader 136 may be configured to assign a score to each of the processed data records, based on collected statistic information 134, to yield scored data records 230 which are stored on the data lake (not shown). Whenever the statistic information 134 or other parameters are changed over time, the scoring process may be carried out again and the score of the data records may be updated accordingly.

In accordance with other embodiments of the present invention, the implementation of a weight matrix for each feature based per each consumer/market specific demands are further provided.

In accordance with some exemplary embodiments of the present invention, a scoring formula or a scoring function may be used in order to evaluate each record over time and adapt it by the consumer/market demands.

Advantageously, by some embodiments of the present invention, it would be possible to score a specific data source and rate it low in case one or more scoring metrics associated with data records obtained from it are below a specific threshold imposed by one or more of the use cases for automotive data consumption. Similarly, a data source of high-quality data may be tagged as ‘premium’ and may be available only to premium data consumers Similar scoring schemes may be applied to specific data records or specific data record types, groups or types. It is also noted that, for certain use cases, a data record or data source may be regarded as inadequate but for another data consumption use case is more than enough.

By way of a non-limiting example, and for illustrative purposes only, some of the criteria associated with the data record and which serve as basis for scoring may be:
Data integrity—the validity of the values within an acceptable range (e.g., speed cannot be a negative number)
Data occurrence—the percentage a certain parameter/field occurring and recurring within the entire data space.
Data accuracy—error rate of the data within the normalized units.
Data freshness—the level of latency and delay of a data record (e.g., since it was created).

In order for an exemplary scoring function to be implemented, there is a need to extract the relevant parameters for a data record message being processed by the server. Such a data record message may be in the following format, based on a simple dictionary of key value data parameters for example:

{

### Latitude: 34.121,

### Longitude: 22.212,

### Heading: 12,

### Speed: 30,

### Odometer: 212122,

### Time: 1513875600,

### Unique_Id: 100340745,

### Provider: Name1,

### Car_Model: Model1_car

}

In accordance with an illustrative non-limiting example, a basic formula to calculate each data parameters with its unique features weight vector per unique market/consumer may be in the following form:

N·Σ₀^{N}F(α)Wα/Σ₀^{N}W_{α} formula (1)

### Wherein:

W_{α}—Weight for each data parameters based on consumer/market weight matrix
F(α)—Function for each data parameter features—in most cases a LUT (look up table) which receives data parameter values and the weight as an input, and provides as an output, a result between 0-1.
Σ₀^{N} w_{α}/N—Average weight between all data parameters per data provider vs. market/consumer.

Following is a non-limiting example of the data scoring process in accordance with some embodiments of the present invention. Example of data integrity valuation in given for simplicity:

Assuming data received from a specific data source (provider) with occurrence of speed in 80% of total records. The server, via the record processing service in the ingestion system may drop another 30% of the invalid values of speed so data integrity may be indicated as 70% of speed data parameters for this data source. By multiplying, the total occurrence of the speed parameters is obtained, which in this case is 0.7*0.8=0.56. Further, by multiplying it by the weight for integrity feature for this parameter, the parameter integrity factor in this case can be achieved,

Similarly, by repeating the aforementioned process for each feature per each data parameter for this provider and by summing it up, the total score for this provider records in this time frame may be obtained.

In accordance with some embodiments of the present invention, the aforementioned process may be expanded to calculate per each vehicle, per data types, and per data providers (data sources).

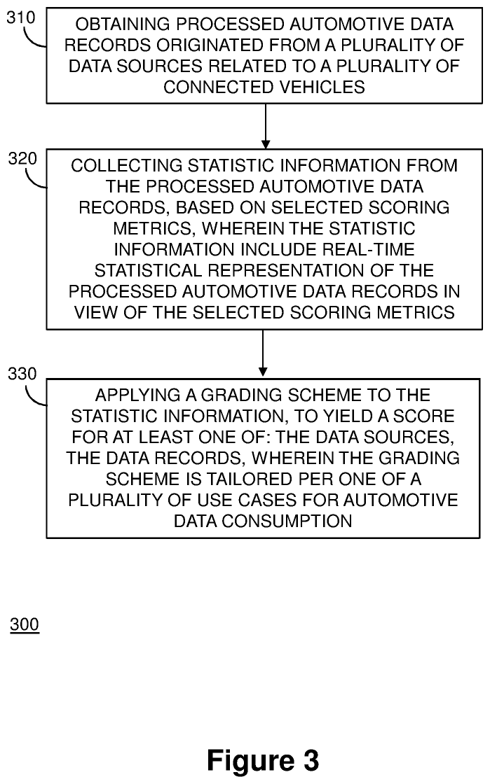

FIG. 3 is a high-level flowchart illustrating a non-limiting exemplary method of scoring automotive data related to connected vehicles and originated from a plurality of data sources, in accordance with some embodiments of the present invention. Method 300 may include the following steps: obtaining processed automotive data records originated from a plurality of data sources related to a plurality of connected vehicles 310; collecting statistic information from said processed automotive data records, based on selected scoring metrics, wherein said statistic information comprise real-time statistical representation of the processed automotive data records in view of the selected scoring metrics 320; and applying a grading scheme to the statistic information, to yield a score for at least one of: the data sources, the data records, wherein the grading scheme is tailored per one of a plurality of use cases for automotive data consumption 330.

According to some embodiments of the present invention, the scoring metrics may be metrics determined as affecting benefit of data consumers from the data records and/or the data sources.

According to some embodiments of the present invention, the scoring metrics may consist of a list comprising: data integrity; data occurrence; data accuracy; and data freshness.

According to some embodiments of the present invention, the data integrity may indicate a validity of values of the data records within an acceptable range.

According to some embodiments of the present invention, the data occurrence may indicate a percentage of certain parameter/field occurring within the plurality of data records.

According to some embodiments of the present invention, the data accuracy may indicate an error rate of the data record within a normalized unit system.

According to some embodiments of the present invention, the data freshness may indicate a level of latency a data record within a specific timeframe.

According to some embodiments of the present invention, the grading scheme may assign a different weight for same scoring metrics for different one of the automotive data consumption use cases.

According to some embodiments of the present invention, the processed automotive data records may originate in raw automotive data records that have been normalized and anonymized.

It should be noted that the method according to some embodiments of the present invention may be stored as instructions in a computer readable medium to cause processors, such as central processing units (CPU), to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to some embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, some aspects of the present invention may be embodied as a system, method or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe some embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of scoring automotive data related to connected vehicles and originated from a plurality of data sources, the method comprising:
obtaining processed automotive data records originated from a plurality of data sources related to a plurality of connected vehicles;
collecting statistic information from said processed automotive data records, based on selected scoring metrics, wherein said statistic information comprise real-time statistical representation of the processed automotive data records in view of the selected scoring metrics; and
applying a grading scheme to the statistic information, to yield a score for at least one of: the data sources, the data records, wherein the grading scheme is tailored per one of a plurality of use cases for automotive data consumption.

2. The method according to claim 1, wherein the scoring metrics are metrics determined as affecting benefit of data consumers from the data records and/or the data sources.

3. The method according to claim 1, wherein the scoring metrics consist of a list comprising: data integrity; data occurrence; data accuracy; and data freshness.

4. The method according to claim 3, wherein the data integrity indicates a validity of values of the data records within an acceptable range.

5. The method according to claim 3, wherein the data occurrence indicates a percentage of certain parameter/field occurring within the plurality of data records.

6. The method according to claim 3, wherein the data accuracy indicates an error rate of the data record within a normalized unit system.

7. The method according to claim 3, wherein the data freshness indicates a level of latency of a data record within a specific timeframe.

8. The method according to claim 1, wherein said grading scheme assigns a different weight for same scoring metrics for different one of the automotive data consumption use cases.

9. The method according to claim 1, wherein the processed automotive data records comprise raw automotive data records that have been normalized and anonymized.

10. A system for scoring automotive data related to connected vehicles and originated from a plurality of data sources, the system comprising:
a server comprising a data scoring module implemented over a computer processor and configured to obtain processed automotive data records originated from a plurality of data sources related to a plurality of connected vehicles; and
a plurality of clients connected to said server over a network and associated with a plurality of data consumers,
wherein said data scoring module comprises:
a statistic information collector configured to collect statistic information from said processed automotive data records, based on selected scoring metrics, wherein said statistic information comprise real-time statistical representation of the processed automotive data records in view of the selected scoring metrics; and
a grader configured to apply a grading scheme to the statistic information, to yield a score for at least one of: the data sources, the data records, wherein the grading scheme is tailored per one of a plurality of use cases for automotive data consumption.

11. The system according to claim 10, wherein the scoring metrics are metrics determined as affecting benefit of data consumers from the data records and/or the data sources.

12. The system according to claim 10, wherein the scoring metrics consist of a list comprising:
data integrity; data occurrence; data accuracy; and data freshness.

13. The system according to claim 12, wherein the data integrity indicates a validity of values of the data records within an acceptable range.

14. The system according to claim 12, wherein the data occurrence indicates a percentage of certain parameter/field occurring within the plurality of data records.

15. The system according to claim 12, wherein the data accuracy indicates an error rate of the data record within a normalized unit system.

16. The system according to claim 12, wherein the data freshness indicates a level of latency a data record within a specific timeframe.

17. The system according to claim 10, wherein said grading scheme assigns a different weight for same scoring metrics for different one of the automotive data consumption use cases.

18. The system according to claim 10, wherein the processed automotive data records originate in raw automotive data records that have been normalized and anonymized.

19. A non-transitory computer readable medium for scoring automotive data related to connected vehicles and originated from a plurality of data sources, the computer readable medium comprising a set of instructions that when executed cause at least one computer processor to:
obtain processed automotive data records originated from a plurality of data sources related to a plurality of connected vehicles;
collect statistic information from said processed automotive data records, based on selected scoring metrics, wherein said statistic information comprise real-time statistical representation of the processed automotive data records in view of the selected scoring metrics; and
apply a grading scheme to the statistic information, to yield a score for at least one of: the data sources, the data records, wherein the grading scheme is tailored per one of a plurality of use cases for automotive data consumption.

20. The non-transitory computer readable medium according to claim 19, wherein the scoring metrics are metrics determined as affecting benefit of data consumers from the data records and/or the data sources.
